(19) United States
(12) Patent Application Publication
(10) Pub. No.: US 2008/0131241 A1
(43) Pub. Date: Jun. 5, 2008

(54) Mobile picker, storage structure and storage system

(76) Inventor: Peter King, Thornbury South Gloucestershire (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/959,498

(22) Filed: Oct. 7, 2004

(30) Foreign Application Priority Data
Oct. 25, 2003 (GB) 0324927.3

(51) Int. Cl. B65G 1/00

(52) U.S. Cl. 414/267; 414/274

(57) ABSTRACT

A mobile picker for selecting an item from a storage unit having a plurality of locations, each location storing an item to be selected, the mobile picker being capable of movement along a guide associated with the storage unit and comprising:
an onboard motor, power supply and control unit, the motor driving the mobile picker and being powered by the power supply and controlled by the control unit; and
a picking tool operable to select an item from a storage location in the storage unit; and
a position detector for detecting the presence of a position indicator associated with the storage unit, wherein the mobile picker is operable to determine the position of the mobile picker from information derived by the position detector.

### RELATED APPLICATIONS

The present application is based on, and claims priority from, GB Application Number 0324927.3, filed Oct. 25, 2003, the disclosure of which is hereby incorporated by reference herein in its entirety.

### FIELD OF THE INVENTION

This invention relates to a storage system, in particular to a data storage system, for example a tape library. This invention also relates to a mobile picker and to a storage structure.

### SUMMARY OF THE INVENTION

Tape libraries are used for the storage of data back-up tapes which can carry critical information/data. It is known to use expensive picking technology to ensure speedy and reliable access to tapes and the data on those tapes. A known tape library physical architecture is based on a picker that runs on some form of rails adjacent a storage unit containing the tapes and usually follows a linear path. The storage unit may be an interchangeable tape magazine or more commonly a fixed unit for storing a plurality of tapes. The picker may be common to a number of tape storage units being mounted on a central pole with tape storage units arranged radially about the picker. The picker moves radially about the central pole to select the respective tape storage unit and then longitudinally along the pole to the desired tape storage location in the selected tape storage unit. The picker is tethered by a bundled cable to both a power supply and an external controller which respectively provide power and control signals/instructions to enable the picker to move along the rail to a specific location, retrieve a tape from the storage structure and transfer the tape, by moving along the rail, to a second location for insertion into a tape drive or a different storage location.

Tape cartridges stored in the above mentioned tape libraries can be high capacity data backup tapes using, for example, one of the Ultrium, SDLT, DLT or DAT formats.

Previously, whilst the configuration of a tape library may be altered to meet the desired capacity, data transfer rate or speed of access requirements, this is achieved by altering the ratio of tapes, tape drives and pickers to one another and is not an operation that can be readily conducted without taking the library off-line or even dismantling the architecture. For example, the capacity of a tape library with a picker running along a single linear axis as shown in FIG. 1 of the accompanying drawings can be increased by extending the linear array of tapes. However, this leads to a compromise in the speed of selection of the tape. It is also difficult to extend the array without dismantling and reconfiguring the picker rail and thereby taking the library off-line. Similarly, it is difficult to increase the capacity of a tape library with a radial array of tapes as shown in FIG. 2 of the accompanying drawings without dismantling the entire architecture of the array of tapes and the storage structure.

A tape library with a two-axis topology as shown in FIG. 3 of the accompanying drawings also allows for high capacity, but a tape library of this architecture is practically restricted to a single picker, thus compromising the speed of tape selection.

Tape libraries with a multiple array of tapes increase the capacity and maintain the speed of transfer, but have the disadvantage that each tape drive only has access to the tapes within its local array. For example, a tape drive may be available on one array but remains idle because the desired tape is on a different array where the tape drive is already in use. Because the pickers are tethered, they cannot “cross over” one another's domains or mutual entanglement or collision will ensue. Thus, in such architectures, the degree of freedom for rearrangement of the existing tape library architecture is limited by the tethered nature of the picker.

Another disadvantage with the above mentioned tape library architectures is that in the event that one picker fails, the entire system fails and would need to be taken off-line for the necessary repairs or replacement.

One aspect of the present invention provides a mobile picker for selecting an item from a storage unit having a plurality of locations, each location storing an item to be selected, the mobile picker being capable of movement along a guide associated with the storage unit and comprising:
an onboard motor, power supply and control unit, the motor driving the mobile picker and being powered by the power supply and controlled by the control unit; and
a picking tool operable to select an item from a storage location in the storage unit; and
a position detector for detecting the presence of a position indicator associated with the storage unit, wherein the mobile picker is operable to determine the position of the mobile picker from information derived by the position detector.

Another aspect of the present invention provides a storage structure comprising:
at least one storage unit having a plurality of locations, each location for storing an item to be selected by a mobile picker;
at least one guide associated with the at least one storage unit; and
at least one position indicator is associated with the at least one storage unit.

A further aspect of the present invention provides a mobile picker for selecting an item from a storage unit having a plurality of locations, each location storing an item to be selected, the mobile picker being capable of movement along a guide associated with the storage unit and comprising:
a motor, power supply and control unit, the motor driving the mobile picker and being powered by the power supply and controlled by the control unit; and
a picking tool operable to select an item from a storage location in the storage unit; and
an actuator operable upon contact with a second mobile picker to isolate at least one component of the second mobile picker.

### BRIEF DESCRIPTION OF THE DRAWING

In order that the present invention may be more readily understood, embodiments thereof will now be described, by way of example only, with reference to the accompanying drawings in which:

FIG. 1 is a schematic representation of a known single axis linear tape library architecture;

FIG. 2 is a schematic representation of a single axis circular tape library architecture;

FIG. 3 is a schematic representation of a two axis linear tape library architecture;

FIG. 4 is a front view of a tape library architecture embodying the present invention showing only the storage structure and guide rails;

FIG. 5 is a side view of a picker and guide rails for use with the storage structure of FIG. 4;

FIG. 6 is a perspective view of two storage structures, only part of one storage structure being shown, a picker and guide rails in accordance with another embodiment of the present invention;

FIG. 7 is a schematic plan view of a storage structure, picker and guide embodying the present invention;

FIG. 8 is a schematic block diagram of the components of a picker and rack module embodying the present invention;

FIGS. 9, 10 and 11 are schematic representations of configurations of tape library architectures possible using the tape library architecture embodying the present invention.

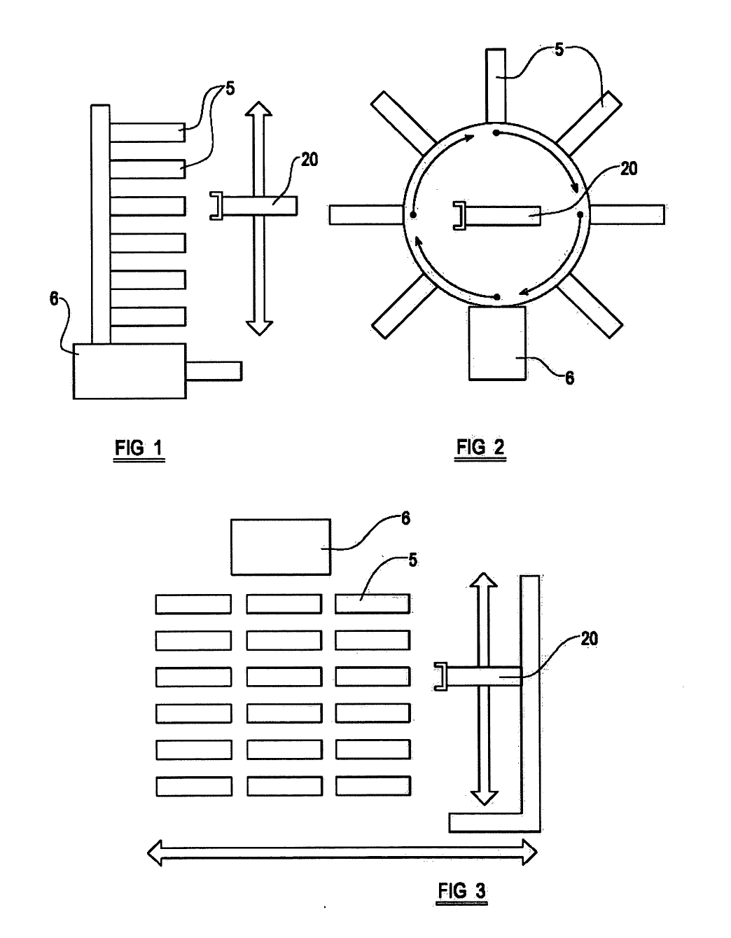

### DETAILED DESCRIPTION OF THE DRAWING

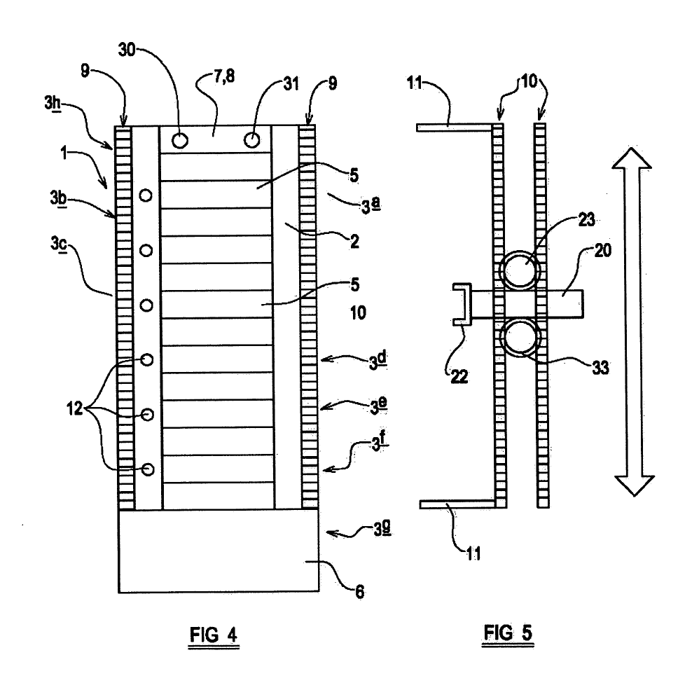

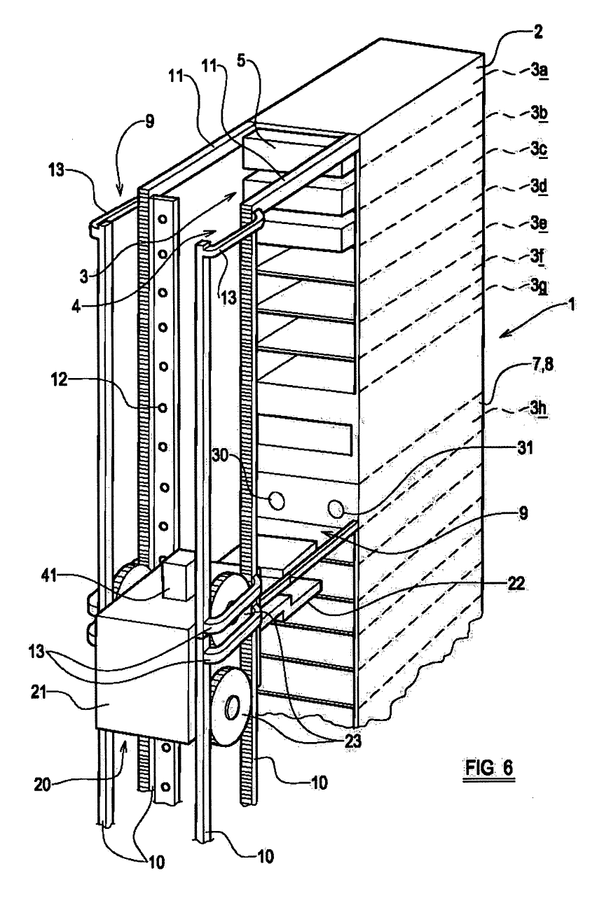

The embodiments relate to a flexible architecture for an item storage system, particularly a tape library. Referring now to FIGS. 4, 5 and 6, a storage structure 1 for use in the storage system comprises a rack module 2 divided into a column of storage locations 3, each storage location 3 having a bay 4 suitable for receiving an item 5 to be stored, in this example a tape cartridge 5. In FIG. 6, there are two rack modules 2 attached to one another in a stack. The upper rack module 2 (of which there is a compete view), has six storage bays 3a-3f for tapes, one bay 3g housing a tape reader 6 and a final bay 3h at the base of the column in which a power supply unit 7 and master control unit 8 are housed. It should be noted that the power supply unit and the rack module 2 is connected to an external power source, typically a mains power source and the master control unit 8 is connected by a data communications link to an overall tape library control unit (not shown).

Preferably, a plurality of such rack modules 2 are provided and can be stacked one on top of the other using snap fit fixings. It is also envisaged that rack modules 2 can be provided in the form of a tape cartridge magazine with bays 3 for tapes only, i.e. without a power supply unit 7 and master control unit 8. The magazines and rack modules not in the form of magazines are interchangeable with one another. It would also be possible for a plurality of individual storage locations and magazines to be stacked one on top of the other and attached together, preferably by a snap-fit arrangement, although it will be appreciated that other fixings such as screws or the like may be used. As shown in FIGS. 4, 5 and 6, the rack modules can be arranged vertically but can also be arranged horizontally against a wall or in racking. The rack modules can also be floor mounted lying on their backs but this is not preferred.

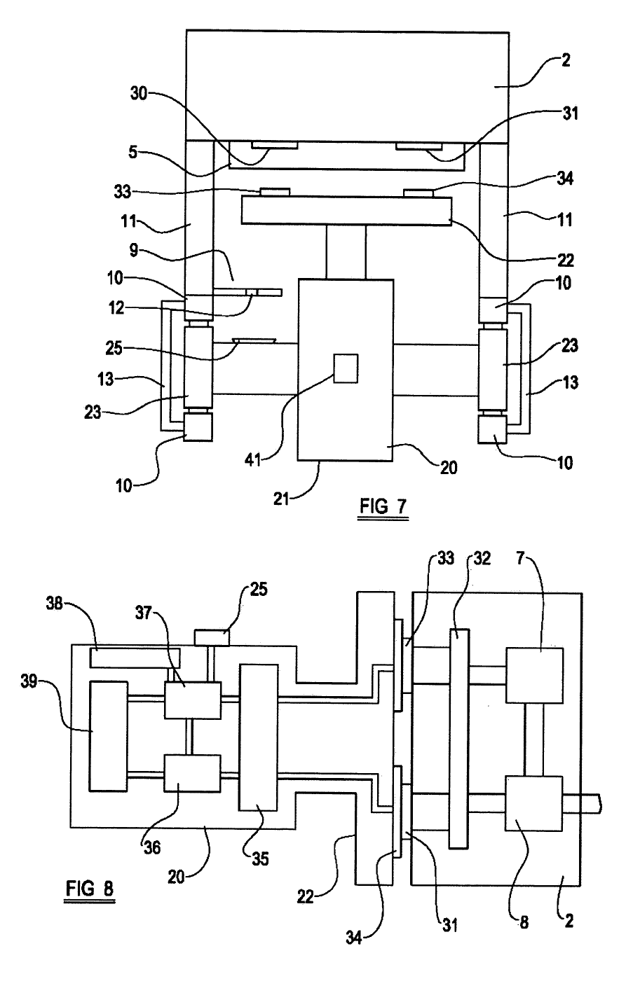

A guide 9 is attached to the storage structure 1. Preferably, the guide 9 is attached to the storage location structure 1 at a position running alongside the bays 4. As shown in FIGS. 4, 5 and 6, the guide 9 runs the entire length of the storage locations 3, and is in the form of two pairs of continuous rails 10 located on opposite sides of the bays 4, in such a way that the storage locations 3 bridge the two pairs of rails 10. In addition to the rack modules 2 being modular, the rails 10 are also modular so that a plurality of guide rails 10 are attached to one another to form a continuous rail of desired length to run alongside the bays 4 or a desired number of rack modules 2. The rails 10 are attached to one another in a snap fit arrangement, thereby enabling the overall length of the guide rail to be extended easily. As shown in FIG. 7, the rails 10 are fixed to the rack module 2 by struts 11 which maintain the rails 10 a predetermined distance away from the rack module 2. It is, however, envisaged that the arrangement shown in FIG. 7 has the rails 10 formed integrally with and as part of the rack module 2, the rails 10 comprising an extension of the sides of the rack module.

In each pair of rails 10, the nearest of the pair to the rack module 2 comprises a drive track and the other of the pair comprises an open channel. The drive track is preferably provided with teeth but can also be an open channel for engagement by a friction drive. These two rails 10 are spaced apart by a pre-determined distance by spacers 13 which span the two rails 10 of each pair so that a pair of drive wheels carried on the picker 20 (to be described later) engage with the drive track and, when the wheels are driven, the picker moves along the guides 9. The picker 20 and its drive wheels are described later.

The tape drive 6 is preferably inserted in the rack module 2 and occupies a whole number of storage locations, preferably two storage locations 3. The opening to the tape drive 6 faces in the same direction as the bays 3 for accommodating the tapes, i.e. facing out toward the rails 10. The power supply occupies a whole number of storage locations, preferably two storage locations. The power supply unit has at least one electrical contact that is capable of providing both power and communications to a mobile picker as will be described in greater detail hereinafter.

The height dimension of storage locations for the power supply unit and the item reader are preferably integral multiples of 1u, where u=4.45 cm and is a standard unit size utilised in 19″ industry standard racking. This uniformity means that the different components can easily be allocated to different positions in the rack module 2 and the rack module 2 can be readily mounted in standard 19″ racking.

Each storage location, tape drive and power supply unit 7 and master control unit 8, has a corresponding position indicator 12. Preferably, the position indicators 12 are located on at least one of the guides 10. However, it is also envisaged that the position indicators 12 could be located on the elements of the rack module 2, i.e. the storage locations 3, tape drive 6 and power supply unit 7 and master control unit 8. As shown in FIGS. 4 and 6, in one example, the position indicators 12 are in the form of a hole formed on the guide 9 that can be detected by an optical detection device carried on the picker and described later. It is also envisaged that the position indicators can be in the form of a mechanical projection or indentation formed on the guide or the rack module, which can be detected by a mechanical detection device carried on the picker and described later.

Referring to FIGS. 5 and 6, a mobile picker 20 is mounted on the rails 10 of the guide 9 for movement along the rails 10.

The mobile picker 20 comprises a casing 21, a pair of clamping jaws 22 and externally mounted wheels. The wheels 23 are mounted one above the other in pairs on opposite sides of the casing 21. The wheels 23 are provided with a perimeter surface that facilitates engagement to and co-operation with a drive track making up one of the rails 10, for example the picker can be configured with the drive wheels and the drive track configured as a co-operating toothed track. The mobile picker 20 further comprises onboard motors 39 operable to drive the wheels 23 and the jaws 22, the motors 39 being connected to an onboard power supply preferably comprising a rechargeable battery pack 36. Further, the mobile picker 20 includes an onboard control unit 37 for monitoring the position of the picker 20 and controlling movement of the picker 20 along the rails 10 and a memory 38 capable of storing data received from the master control unit 8. The jaws of the picker are operable to clamp tapes held in the bays 4, remove the tapes from the bays and insert the tapes in the tape drive 6 or other bays 4.

The rechargeable battery pack 36 onboard the mobile picker 20 is connectable to the power supply unit 7 held within the rack module 2. Preferably, the mobile pickers are provided with power to recharge their onboard battery packs by means which allow them to be oriented in either direction when being fixed to the rails 9.

As can be most readily seen from FIG. 7 of the accompanying drawings, the picker 20 also carries an optical detection device 25 which may be in the form of a charge coupled device (CCD) or other photosensitive electrical element for detecting the presence or absence of the position indicator holes 12 formed on the guide 9. The holes and the optical detection device are arranged with respect to one another so that a signal is generated by the optical detection device 25 when the picker 20 passes by a position indicator hole 12 and detects a difference of optical contrast caused between the hole 12 and the guide 9.

Electrical contacts 33, 34 are provided on the picker 20 to co-operate with and connect to the electrical contacts 30, 31 of the power supply unit 7 and master control unit 8 housed in the rack module 2. Preferably, the contacts 33, 34 on the picker are provided on the jaws 22. In addition to providing an electrical connection to the power supply unit 7, the contacts 33, 34 of the picker 20 also provide data connection between the picker and the master control unit 8. The contacts therefore establish a power and data bus between the picker 20 and the rack module 2.

FIG. 8 illustrates a schematic block diagram showing the connections between the picker 20 and the power supply unit 7 and master control unit 8. As previously described, in relation to the power supply unit 7 and master control unit 8, these are housed in a common bay 3h in the rack module 2 module and present a pair of electrical contacts 30, 31. Preferably, the power supply unit 7 and master control unit 8 present their respective outputs to the electrical contacts 30, 31 over a combined power and data bus 32. Although a combined power and data bus is preferred, the buses could be implemented separately.

The connection to the picker 20 is made by the electrical contacts 33, 34 carried on the picker 20 which are again routed through an onboard power and data bus 35 to the rechargeable battery 36 and onboard controller 37 depending upon whether the signal is a power signal (directed to the rechargeable battery 36) or a control or data signal (directed to the onboard controller 37).

Coupling between the buses and the picker could be electromagnetic rather than by electrical contacts. In the case of the data bus, an optical connector offers a convenient coupling. Preferably, in the case of a combined power and data bus, the power and communications bus 32 superimposes a high frequency data signal on the substantially low frequency ac power signal. Control signals and information are passed from the controller to the onboard memory 38 and the controller 37 is also used to control the motors 39 for driving the picker wheels and actuating the jaws 22. Further, the onboard controller 37 is operable to receive signals from the detection device 25 mounted on the picker.

As previously described with respect to the position indicator holes 12, these need not necessarily be in the form of holes but could be some other medium which contrasts optically with the guides 9 or rack module upon which they are provided. It is simply important that the optical detection device 25 is able to distinguish the position indicator 12 from the backgrounds. It is also envisaged that the optical indicator 12 may be in the form of a bar code and the optical detection device 25 in the form of a bar code reader. Further, it is envisaged that the position indicator 12 could be a mechanical position indicator in the form of a projection or indentation formed on the guides 9 or rack module 2 and detected by a mechanical detection device carried on the picker 20. The mechanical detection device could be in the form of a microswitch or other form of trip switch actuated by the mechanical position indicator. The position indicator can also be configured electromagnetically as either an active electromagnetic device incorporating a coil and a pick-up or as a passive electromagnetic device incorporating a magnet and a pick-up.

In use, the mobile picker 20 has an initial “park” position along the guides 9 in which the picker 20 is positioned adjacent to the power supply unit 7 and master control unit such that the electrical contacts of the power supply unit 7 and master control unit 8 are registered with and connected to the electrical contacts of the mobile picker 20. In its “park” position, the mobile picker receives power from the external power supply through the power supply, when the respective electrical contacts are connected to each other, thereby recharging the onboard power supply, rechargeable battery 36. In its park position, the mobile picker 20 also receives information over the power and communications bus 32, 35 from the master control unit 8.

The nature of the instructions sent by the master control unit 8 to the on-board controller 37 is intentionally very simple so as to minimise the cost of the picker on-board components. For example, the mobile picker 20 may receive instructions to move from its park position, position x, to position x+4 (the location of a tape 5 in a storage location), retrieve the tape from its position in the storage location and transport it to position x+1 (the location of a tape drive) and insert the tape into the tape drive, await the re-emergence of the tape from the tape drive, transport the tape back to its storage location, position x+4, insert the tape into the bay 4 of the storage location and return to its park position to await further instructions. These instructions are stored in the memory 38 of the mobile picker and executed by the onboard controller 37, so that no communication between the mobile picker and the rack module 2 is necessary during the execution of the task.

An incremental count is provided by the optical or mechanical detection device and recorded by the onboard controller 37 in response to the number of position indicators 12 detected. This enables the onboard controller 37 of the mobile picker 20 to determine where the picker 20 is in relation to the park position. For example, if the park position is zero, to move to position x+4, the controller 37 detects when the incrementing counter has counted 4 indicators 11 on the guides in the positive direction (it is possible for the mobile picker to move above and below the “park” position). To move to position x+3, the controller 37 detects when the increment count provided by the optical or mechanical detection device 25 counts 1 indicator in the negative direction. Direction of movement is sensed by tapping a direction signal from the motor control function of the controller 37. To move back to the position x+4, the controller 37 determines when the incremental count counts 1 indicator in the positive direction. To return to the park position, the control unit determines when the incremental count counts 4 indicators in the negative direction.

The park position at the power supply unit 7 and master control unit 8 is the default position of the mobile picker 20. The mobile picker is pre-set to return to this default position in two different circumstances. Firstly, once each task has been successfully executed, the mobile picker 20 returns to the default position, in order to receive further instructions. Secondly, after a specified period of time, the mobile picker returns to the default position in order to recharge the onboard battery 36 of the mobile picker 20, thereby preventing the mobile picker 20 from running out of power whilst it is completing a task.

With regard to picker position determination, in this arrangement, one specific power supply is set as the zero position for the incremental counter of the mobile picker. Therefore, even in the event that the mobile picker receives instructions from a different power supply unit 7 and master control unit 8, the onboard controller 37 determines the position of the mobile picker with respect to a specific power supply unit 7 and master control unit 8. It is also envisaged that when the mobile picker is in the “park” position with any of the power supply units 7 and master control units 8, the power supply zeroes the incremental count in the onboard controller 37 and, therefore, the present power supply unit 7 and master control unit 8 at which the picker is parked becomes the datum for future relative movement.

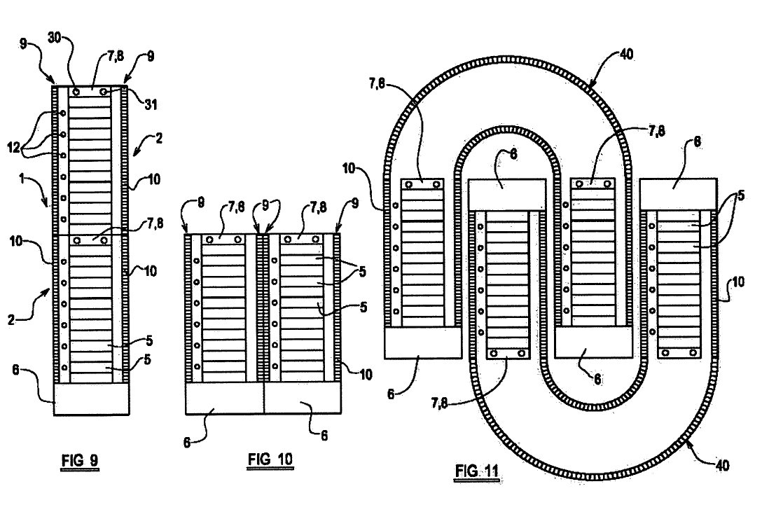

As shown in FIG. 9, the illustrated storage structure comprises two separate rack modules 2, which have been snap-fit together, one on top of the other. The first rack module comprises a tape drive as its base unit with rails extending upwardly therefrom for the first rack module 2 which terminates in a power supply unit 7 and master control unit 8. Above that is connected the second rack module 2 which houses six tape bays and a further power supply unit 7 and master control unit 8, the guide rails from the first rack module extending towards and snap-fitting into engagement with the rails 9 of the second rack module 2 so as to provide a continuous rail for guiding the one or more mobile pickers 20 carried on the rail. If the array shown in FIG. 9 is lengthened to incorporate two tape drives, then this would allow the two rack modules 2 to be serviced by two pickers 20.

Turning to FIG. 10, rack modules 2 can be assembled side by side in a compact manner. Should a picker fail, then a replacement picker can simply be added to the rails and the old picker taken off. The new picker would pick up its instruction information from the park position and carry on the tasks assigned to it. There is no need to have an “intelligent” picker or a “dedicated” picker as all the information necessary for the picker to carry out its tasks is fed to it by the master control unit 8 from the park position.

FIG. 11 shows an architecture for a tape library in which two pairs of rack modules 2 are provided one at either end of a continuous guide 9. Between each pair of rack modules 2, the guide defines a semi-circular transfer path so that, if needed, a single picker could service both rack modules 2 transferring between the respective rack modules 2 using the semi-circular transfer rail 40. Interleaved with one pair of rack modules is another pair of rack modules joined together by a further semi-circular transfer rail 40 but in the opposite sense. Preferably, the two rack modules 2 which are joined together by the transfer rail 40 are serviced by a pair of mobile pickers. Should one picker become disabled or function incorrectly, then the other picker can take over its function by engaging the non-functioning picker and in such engagement operating an actuator 41 protruding from the non-functioning picker to physically disable and electrically isolate the motors 39 within the non-functioning picker. Further, it is preferred that in the act of engaging with the non-functioning picker, the functioning picker mechanically links or couples to the non-functioning picker so as to follow the functioning picker from one rack module to another rack module whilst it performs its tasks. The non-functioning picker would therefore be in a free wheel mode and be readily maneuvered by the functioning picker. The non-functioning picker could also be shunted to and parked in an area of the tape library where infrequent or no access is required. Such an architecture therefore offers a certain level of redundancy allowing the tape library to continue functioning even though half of the pickers which would normally service two such rack modules 2, are out of action.

The mobile picker can carry out more than one task before returning to the “park” position.

It will be apparent from the above that the embodiments facilitate provision of a storage system that can readily be reconfigured for a desired capacity, data transfer rate and speed of access requirement, and which does not suffer from at least some of the problems of known tethered pickers.

The present invention is not limited to tape libraries but is also applicable to high value items such as biological samples which are held in storage or collection facilities, to other storage or items such as CDs, DVDs, video cassettes and the like.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A mobile picker for selecting an item from a storage unit having a plurality of locations, each location storing an item to be selected, the mobile picker being capable of movement along a guide associated with the storage unit and comprising:
an onboard motor, power supply and control unit, the motor driving the mobile picker and being powered by the power supply and controlled by the control unit;
a picking tool operable to select an item from a location of the storage unit; and
a position detector for detecting the presence of position indicators associated with the storage unit,
wherein the mobile picker maintains a count of the position indicators detected by the position detector to determine the position of the mobile picker.

2. A mobile picker according to claim 1, wherein the position detector comprises at least one selected from an optical, a mechanical and an electromagnetic position detector.

3. A mobile picker according to claim 1, comprising a memory associated with the control unit and capable of receiving and storing instructions for execution of at least one task.

4. A mobile picker according to claim 1, comprising an actuator operable upon contact with a further mobile picker to isolate at least one electrical component of the further mobile picker.

5. A mobile picker according to claim 1, comprising an actuator operable upon contact with a further mobile picker to isolate at least one mechanical component of the further mobile picker.

6. A mobile picker according to claim 1, wherein the mobile picker includes a coupler to couple the mobile picker to a further mobile picker upon contact therebetween.

7. A storage structure comprising:
at least one storage unit having a plurality of locations, each location for storing an item to be selected by a mobile picker;
at least one guide associated with the at least one storage unit along which the mobile picker moves; and
a plurality of position indicators spaced from one another and disposed on the at least one guide.

8. A storage structure according to claim 7, wherein the guide is a guide rail connected to the at least one storage unit.

9. A storage structure according to claim 7, wherein the position indicators are substantially identical to one another.

10. A storage structure according to claim 7, wherein each position indicator corresponds to a location of the at least one storage unit.

11. A storage structure according to claim 7, wherein each position indicator comprises at least one selected from a hole, an indentation or protrusion and an active or a passive electromagnetic device.

12. A storage structure according to claim 7, wherein the at least one storage unit comprises attachment means for attaching the at least one storage unit to a further storage unit such that the guides associated with the at least one storage unit and the further storage unit form at least one continuous guide.

13. A storage structure according to claim 7, wherein the at least one storage unit comprises at least one item reader for receiving at least one item from the mobile picker.

14. A storage structure according to claim 13, wherein the at least one item reader is a tape drive.

15. A storage system comprising:
at least one storage unit having a plurality of locations, each location for storing an item to be selected by a mobile picker;
at least one guide associated with the at least one storage unit;
a plurality of position indicators associated with the at least one storage unit; and
a mobile picker moveably mounted on the at least one guide for selecting an item from a storage unit, the mobile picker comprising:
an onboard motor, power supply and control unit, the motor driving the mobile picker and being powered by the power supply and controlled by the control unit;
a picking tool operable to select an item from a location of the at least one storage unit; and
a position detector for detecting the presence of the position indicators associated with the at least one storage unit,
wherein the mobile picker maintains a count of the position indicators detected by the position detector to determine the position of the mobile picker.

16. A storage system according to claim 15, wherein the onboard power supply of the mobile picker comprises a rechargeable battery and the storage structure further comprises at least one power supply unit to couple with the mobile picker to recharge the rechargeable battery.

17. A storage system according to claim 15, wherein the mobile picker further comprises control data receiving apparatus and the storage structure further comprises at least one storage structure control unit having control data supply apparatus operable to co-operate with the control data receiving apparatus of the mobile picker to supply data to the onboard control unit of the mobile picker.

18. A storage system comprising:
at least one storage unit having a plurality of locations, each location for storing an item to be selected by a mobile picker;
at least one guide associated with the at least one storage unit;
a plurality of position indicators spaced from one another and disposed on the at least one guide;
a mobile picker moveably mounted on the at least one guide for selecting an item from a storage unit, the mobile picker comprising:
an onboard motor, power supply and control unit, the motor driving the mobile picker and being powered by the power supply and controlled by the control unit;
a picking tool operable to select an item from a location of the at least one storage unit; and
a position detector for detecting the presence of the position indicators disposed on the at least one guide,
wherein the mobile picker is operable to determine the position of the mobile picker from information derived from the position detector.

19. A data storage library comprising:
at least one storage unit having a plurality of locations, each location for storing a data storage item to be selected by a mobile picker;
at least one guide associated with the at least one storage unit;
a plurality of position indicators associated with the at least one storage unit; and
a mobile picker moveably mounted on the at least one guide for selecting a data storage item from a storage unit, the mobile picker comprising:
an onboard motor, power supply and control unit, the motor driving the mobile picker and being powered by the power supply and controlled by the control unit;
a picking tool operable to select a data storage item from a location of the at least one storage unit; and
a position detector for detecting the presence of the position indicators associated with the at least one storage unit,
wherein the mobile picker maintains a count of the position indicators detected by the position detector to determine the position of the mobile picker.

20. A data storage library according to claim 19, wherein each data storage item is one of a tape cartridge, CD or DVD.

21. A mobile picker for selecting an item from a storage unit having a plurality of locations, each location storing an item to be selected, the mobile picker being capable of movement along a guide associated with the storage unit and comprising:
a motor, power supply and control unit, the motor driving the mobile picker and being powered by the power supply and controlled by the control unit; and
a picking tool operable to select an item from a storage location in the storage unit; and
an actuator operable upon contact with a second mobile picker to isolate at least one component of the second mobile picker.

22. A mobile picker according to claim 21, wherein the actuator is operable upon contact with the second mobile picker to isolate at least one of an electrical and a mechanical component of the second mobile picker from a power supply.

23. A mobile picker according to claim 21, comprising a coupler to couple the mobile picker to the second mobile picker upon contact therebetween.

24. A storage system comprising:
at least one storage unit having a plurality of locations, each location for storing an item to be selected by a mobile picker;
at least one guide associated with the at least one storage unit;
a plurality of position indicators associated with the at least one storage unit; and
a plurality of mobile pickers moveably mounted on the at least one guide for selecting items from the at least one storage unit, each mobile picker comprising:
a motor, power supply and control unit, the motor driving the mobile picker and being powered by the power supply and controlled by the control unit;
a picking tool operable to select an item from a location in the at least one storage unit; and
an actuator operable upon contact with a second mobile picker to isolate at least one component of the second mobile picker.
